(19) United States
(12) Patent Application Publication
(10) Pub. No.: US 2018/0248496 A1
(43) Pub. Date: Aug. 30, 2018

(54) ELECTROSTATIC CONVERTER

(71) Applicant: COMMISSARIAT À L'ENERGIE ATOMIQUE ET AUX ENERGIES ALTERNATIVES, Paris (FR)

(72) Inventors: Matthias PEREZ, Grenoble (FR); Sébastien BOISSEAU, Echirolles (FR); Matthias GEISLER, Grenoble (FR)

(73) Assignee: COMMISSARIAT À L'ENERGIE ATOMIQUE ET AUX ENERGIES ALTERNATIVES, Paris (FR)

(21) Appl. No.: 15/881,201

(22) Filed: Jan. 26, 2018

(30) Foreign Application Priority Data
Jan. 26, 2017 (FR) 1750647

(51) Int. Cl. H02N 1/00

(52) U.S. Cl. CPC H02N 1/006

(57) ABSTRACT

An electrostatic converter includes: a stator provided with at least one electrode; a rotor including at least one blade provided with a counter-electrode, the blade being movable in rotation around an axis of rotation designed to coincide with a direction of an air flow; the electrode or the counter-electrode being coated with a dielectric material able to be biased, the stator and rotor being configured to allow a first relative movement between the electrode and counter-electrode around the axis of rotation of the rotary shaft of the rotor so as to generate an electrostatic torque when the rotor performs a rotation. The stator and the rotor are configured to allow a second relative movement between the electrode and counter-electrode so as to modify the electrostatic torque generated.

### FIELD OF THE INVENTION

The invention relates to the technical field of electrostatic converters of turbine, micro turbine, wind generator, or micro wind generator type.

The invention finds its application in particular for energy recovery, in the automobile, aeronautics and housing fields.

### STATE OF THE PRIOR ART

An electrostatic converter known from the state of the art, in particular from the document DE 20 2012 009 612, comprises:
a stator provided with at least one electrode;
a rotor comprising at least one blade provided with a counter-electrode, the blade being designed to receive an air flow, the blade being movable in rotation with respect to the stator around an axis of rotation designed to coincide with a direction of the air flow, the counter-electrode being coated with a dielectric material suitable to be polarised; the stator and the rotor being configured to allow a first relative rotational movement between the electrode and counter-electrode, around the axis of rotation of the blade, so as to generate an electrostatic torque when the rotor performs a rotation.

Such an electrostatic converter is of the wind turbine type and forms an energy recovery unit. The kinetic power of the air flow is converted into mechanical power and then into electric power. First of all, the turbine converts the air flow into a relative rotational movement between the stator and the rotor. The relative rotational movement then generates an electrostatic torque, thereby inducing electric capacitance variations between the electrode or electrodes of the stator and the counter-electrode of the blade or each blade on a rotation of the rotor, which induces an electrostatic energy variation resulting in the emergence of an electric current.

Such an electrostatic converter of the prior art is not totally satisfactory in so far as it can only recover energy when the air flow has a flowrate higher than a threshold. Flowrates of the fluid lower than the threshold are therefore unexploitable.

An electrostatic converter is therefore sought to be provided that is able to recover energy, including for low air flowrates, i.e. less than 50 m/s, preferentially less than 10 m/s, and more preferentially less than 5 m/s.

### SUMMARY OF THE INVENTION

The object of the invention is to either totally or partially overcome the above-mentioned shortcomings. For this purpose, the object of the invention is to provide an electrostatic converter comprising:
a stator provided with at least one electrode;
a rotor comprising at least one blade provided with a counter-electrode, the blade being designed to receive an air flow, the blade being movable in rotation with respect to the stator around an axis of rotation designed to coincide with a direction of the air flow, the electrode or the counter-electrode being coated with a dielectric material suitable to be polarised;
   the stator and rotor being configured to allow a first relative rotational movement between the electrode and counter-electrode, around the axis of rotation of the blade, so as to generate an electrostatic torque;

remarkable in that the stator and rotor are configured to allow a second relative movement between the electrode and counter-electrode so as to modify the electrostatic torque generated.

Due to such a second relative movement between the electrode and counter-electrode, an electrostatic converter according to the invention thus enables a variable electrostatic torque to be obtained. In the state of the art, the electrostatic torque is constant, and is determined by the first relative rotational movement between the electrode and counter-electrode, for a given polarisation of the dielectric material. In particular, such a second relative movement makes it possible to envisage reducing the electrostatic torque when the speed of the air flow is low in order to recover energy.

The electrostatic converter according to the invention can comprise one or more of the following features.

According to one feature of the invention, the counter-electrode presents an orthogonal projection on the electrode for a given position of the rotor, the orthogonal projection having an area, the second relative movement between the electrode and counter-electrode modifying the area for the given position of the rotor.

One resulting advantage is thus to be able to increase (respectively decrease) the electrostatic torque while at the same time increasing (respectively reducing) the capacitive surface. In other words, for a given position of the rotor, the second relative movement between the electrode and counter-electrode modifies the overlap surface (in the sense of a contact-free overlap) of the electrode and counter-electrode, which enables the electrostatic torque generated to be modified.

According to one feature of the invention, the electrode and counter-electrode are separated by a certain distance for a given position of the rotor, the second relative movement between the electrode and counter-electrode modifying this distance for the given position of the rotor.

One resulting advantage is thus to be able to increase (respectively decrease) the electrostatic torque while at the same time reducing (respectively increasing) the distance between the electrode and counter-electrode (also called air-gap). In other words, for a given position of the rotor, the second relative movement between the electrode and counter-electrode modifies the air-gap, which enables the electrostatic torque generated to be modified.

According to one feature of the invention, the rotor comprises a rotary shaft on which the blade is mounted, the air flow being designed to generate an optimal mechanical torque, noted C_{meca}, exerted on the rotary shaft, the electrostatic converter comprising an adjustment device configured to adjust the second relative movement between the electrode and counter-electrode so that the modified electrostatic torque, noted C_{elec}, verifies 0.85×C_{meca}≤C_{elec}≤C_{meca}, preferentially 0.9×C_{meca}≤C_{elec}÷C_{meca}, and more preferentially C_{elec}=C_{meca}.

One resulting advantage is thus to be able to optimise the energy recovery when the electrostatic torque tends towards the mechanical torque, in particular when the speed of the air flow is low.

According to one feature of the invention, the second relative movement between the electrode and counter-electrode increases the generated electrostatic torque, the adjustment device being arranged to oppose said second relative movement.

Thus, when the speed of the air flow increases thereby causing the second relative movement to take place, one resulting advantage is to be able to maintain a low electrostatic torque in order to recover energy under transient conditions.

According to one feature of the invention, the adjustment device comprises a spring arranged to oppose the second relative movement.

One resulting advantage is thus the simplicity of producing such an adjustment device. Furthermore, the linear behaviour of the spring is particularly well-suited in the case where the second relative movement between the electrode and counter-electrode only modifies the overlap surface (in the sense of a contact-free overlap) of the electrode and counter-electrode.

According to one feature of the invention, the adjustment device comprises first and second magnets respectively arranged on the stator and on the rotor, with identical polarities facing one another, to oppose the second relative movement.

One resulting advantage is thus the simplicity of producing such an adjustment device. Furthermore, the non-linear behaviour of the first and second magnets is particularly well-suited in the case where the second relative movement between the electrode and counter-electrode modifies:
both the overlap surface of the electrode and counter-electrode (in the sense of a contact-free overlap),
and the distance between the electrode and counter-electrode, i.e. the air-gap.

According to one feature of the invention, the blade is mounted movable in translation with respect to the stator, in a direction of translation parallel to the axis of rotation of the blade, so as to allow the second relative movement between the electrode and counter-electrode.

According to one feature of the invention, the electrode is mounted swivelling with respect to the stator, around a swivel axis perpendicular to the axis of rotation of the blade, so as to allow the second relative movement between the electrode and counter-electrode.

Swivelling of the electrode takes place in a direction tending to move one end of the electrode away from the at least one blade of the rotor.

According to one feature of the invention, the electrostatic converter comprises a stop arranged to define an end-of-travel position of the second relative movement between the electrode and counter-electrode, the stop being arranged in such a way that the electrode and counter-electrode are located at a distance from one another in the end-of-travel position.

One resulting advantage is thus to prevent any contact or impact between the electrode and counter-electrode leading to energy losses, or even to depolarisation of the dielectric material.

According to one feature of the invention, the dielectric material is an electret.

One resulting advantage is thus to obviate the necessity of an electric power supply dedicated to polarisation of the dielectric material, as an electret has a quasi-permanent polarisation state.

### BRIEF DESCRIPTION OF THE DRAWINGS

Other features and advantages will become apparent from the detailed description of different embodiments of the invention, the description being accompanied by examples and references to the appended drawings.

FIG. 1 is a schematic view illustrating the operating principle of an electrostatic converter.

FIG. 2 is a schematic transversal cross-sectional view of an electrostatic converter of the prior art with a constant electrostatic torque.

FIG. 3 is a schematic longitudinal cross-sectional view of the electrostatic converter illustrated in FIG. 2.

FIG. 4 is a schematic longitudinal cross-sectional view of an electrostatic converter according to the invention, illustrating a first embodiment of the second relative movement between the electrode and counter-electrode.

FIG. 5 is a schematic longitudinal cross-sectional view of an electrostatic converter according to the invention, illustrating a second embodiment of the second relative movement between the electrode and counter-electrode.

FIG. 6 is a schematic longitudinal cross-sectional view of an electrostatic converter according to the invention, illustrating a third embodiment of the second relative movement between the electrode and counter-electrode.

FIG. 7 is a schematic longitudinal cross-sectional view of an electrostatic converter according to the invention, illustrating a first embodiment of the adjustment device of the second relative movement, when the second relative movement is performed according to the first embodiment (cf. FIG. 4).

FIGS. 8 and 9 are schematic longitudinal cross-sectional views of an electrostatic converter according to the invention, illustrating the first embodiment of the adjustment device of the second relative movement, when the second relative movement is performed according to the second embodiment (cf. FIG. 5).

FIG. 10 is a schematic longitudinal cross-sectional view of an electrostatic converter according to the invention, illustrating a second embodiment of the adjustment device of the second relative movement, when the second relative movement is performed according to the third embodiment (cf. FIG. 6).

FIG. 11 is a graph illustrating the variation of the electrostatic torque (plot A, in N.m) generated by an electrostatic converter according to the invention (when the second relative movement is performed according to the first embodiment, cf. FIG. 4), versus the speed of the air flow (in m/s). The mechanical torque (plot B, in N.m), exerted on the rotary shaft and generated by the air flow, is also represented versus the speed of the air flow. Finally, the electrostatic torque (plot C, in N.m) generated by an electrostatic converter of the state of the art is represented versus the speed of the air flow. The hatched part illustrates the flowrate area where energy extraction is possible, unlike plot C.

FIG. 12 is a graph illustrating the variation of the electrostatic torque (plot A, in N.m) generated by an electrostatic converter according to the invention (when the second relative movement is performed according to the third embodiment, cf. FIG. 6), versus the speed of the air flow (in m/s). The mechanical torque (plot B, in N.m), exerted on the rotary shaft and generated by the air flow, is also represented versus the speed of the air flow. Finally, the electrostatic torque (plot C, in N.m) generated by an electrostatic converter of the state of the art is represented versus the speed of the air flow. The hatched part illustrates the flowrate area where energy extraction is possible, unlike plot C.

FIG. 13 is a schematic longitudinal cross-sectional view of an electrostatic converter according to the invention illustrating an embodiment where the rotor and rotary shaft are securedly united in rotation.

FIGS. 14 to 16 are schematic longitudinal cross-sectional views of an electrostatic converter according to the invention, illustrating different embodiments where the electrode and counter-electrode are located downstream from the rotor, the rotor and the rotary shaft being securedly united in rotation.

What is meant by “longitudinal” is a cross-section in a direction extending along the axis of rotation (x) of the blade, or in a direction extending along the rotary shaft of the rotor.

What is meant by “transverse” is a cross-section in a direction (y) perpendicular to the axis of rotation (x) of the blade, or perpendicular to the rotary shaft of the rotor.

### DETAILED DESCRIPTION OF THE EMBODIMENTS

For the different embodiments, the same reference numerals will be used for parts that are identical or which perform the same function, for the sake of simplification.

One object of the invention is to provide an electrostatic converter comprising:
a stator 1 provided with at least one electrode 10;
a rotor 2 comprising at least one blade 3 provided with at least one counter-electrode 30, the blade 3 being designed to receive an air flow, the blade 3 being movable in rotation with respect to the stator 1 around an axis of rotation x designed to coincide with a direction of the air flow;

the electrode 10 or counter-electrode 30 being coated with a dielectric material 4 suitable to be biased, the stator 1 and rotor 2 being configured to allow a first relative rotational movement M₁ between the electrode 10 and counter-electrode 30, around the axis of rotation x of the blade 3 and possibly of the rotary shaft 20, so as to generate an electrostatic torque;

the electrostatic converter being remarkable in that the stator 1 and rotor 2 are configured to allow a second relative movement M₂ between the electrode 10 and counter-electrode 30 so as to modify the electrostatic torque generated.

### First Relative Movement

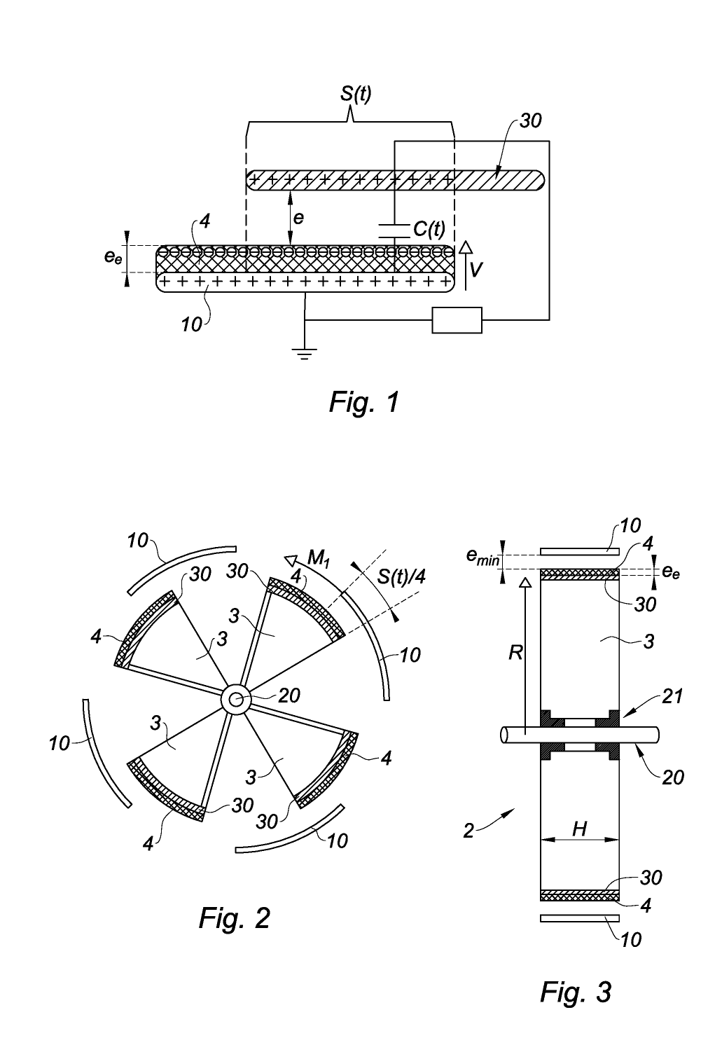

As illustrated in FIGS. 1 and 2, the electrostatic converter uses an electric capacitance C(t) variable versus time t to convert a mechanical rotational energy into electric power.

To do this, the dielectric material 4 is biased. The dielectric material 4 is advantageously an electret. The electret is advantageously selected from the group comprising a polytetrafluoroethylene (PTFE) such as Teflon®, a tetrafluoroethylene and hexafluoropropylene copolymer (FEP), a SiO₂—Si₃N₄ stack, and an amorphous perfluorinated copolymer such as Cytop®. An electret is an electrically charged dielectric able to keep its charge over a period of years. An electret behaves as a permanent electric dipole. However, the dielectric material 4 can be biased with another biasing source such as a high-voltage capacitor or by triboelectricity. If there is no electret, the dielectric material 4 is advantageously selected from the group comprising polyvinylidene fluoride (PVDF), a polyimide such as Kapton®, polymethyl methacrylate (PMMA), and nylon. Advantageously, the dielectric material 4 presents a thickness eₑ comprised between 1 μm and 125 μm, preferably comprised between 25 μm and 100 μm.

The first relative movement M₁ between the electrode 10 and counter-electrode 30 causes displacement of the biased dielectric material 4 and displacement of charges. The electrostatic converter transforms any variation of geometry, expressed as a variation of the electric capacitance C(t), into electricity. The electric power P_{elec} of the dielectric converter is directly proportional:
to the electric capacitance variation (Cₘₐₓ−Cₘᵢₙ) on a rotation of the rotor 2,
to the square of the biasing voltage V of the dielectric material 4,
to the speed of rotation w of the rotor 2,
to the number N of electrodes 10 (each being associated with a counter-electrode 30).

A formula of the electric power P_{elec} can be established as follows:

$$\{ \begin{matrix}C \approx \frac{S {ɛ}_{0}}{e} if {e}_{e} << e \\ {P}_{elec} = \frac{1}{2} ( {C}_{max} - {C}_{min} ) \times N \times {V}^{2} \times ω\end{matrix}$$

where:
ε₀ is vacuum permittivity,
eₑ is the thickness of the dielectric material 4,
e is the distance between the electrode 10 and counter-electrode 30 (also called air-gap or distance between electrodes),
S is the mean, on a rotation of the rotor 2, of the overlap surface S(t) in the sense of a contact-free overlap of the electrode 10 and counter-electrode 30.

The term ½ (Cₘₐₓ−Cₘᵢₙ)×N×V² has the dimension of an electrostatic torque, noted C_{elec}. In the state of the art illustrated in FIG. 3, for a given position of the rotor 2, the geometric parameters (e, S) are fixed and do not enable a variable electrostatic torque to be generated.

In the invention on the other hand, the second relative movement M₂ between the electrode 10 and counter-electrode 30 enables the geometric parameters (e, S) to be modified for a given position of the rotor 2, thereby modifying the electrostatic torque generated to obtain a variable electrostatic torque. The formula of the electrostatic torque is the following:

$${C}_{elec} = \frac{1}{2} \times \frac{S {ɛ}_{0}}{e} \times N \times {V}^{2} .$$

### Second Relative Movement: Principle

Wth R being the radius of the blade 3 and U the speed of the air flow, a specific speed λ of the blade 3 can be associated according to the following formula:

$$λ = \frac{ω R}{U}$$

The rotor 2 undergoes a thrust force T in the direction x of the air flow and develops a mechanical power P_{meca} the optimal values of which (index “opt”) can be determined by the following formulas:

$$\{ \begin{matrix}T = {T}_{opt} = \frac{4}{9} ρπ {R}^{2} {U}^{2} \\ {P}_{meca} = {P}_{{meca}_{—} opt} = \frac{8}{27} ρπ {R}^{2} {U}^{3}\end{matrix}$$

where ρ is the air density.

The associated optimal mechanical torque C_{meca}_{_}ₒₚₜ is therefore equal to:

$${C}_{{meca}_{—} opt} = \frac{{P}_{{meca}_{—} opt}}{ω} = \frac{8}{27} \frac{ρπ {R}^{3} {U}^{2}}{λ}$$

The electrostatic converter generates an electrostatic torque C_{elec} opposing the mechanical torque exerted on the rotor 2. Ideally, to extract a maximum amount of energy, the following relation must be verified to optimise the electrostatic torque:

C_{elec}_{_}ₒₚₜ=C_{meca}_{_}ₒₚₜ

A relation arises between the optimal electrostatic torque and the thrust force undergone by the rotor 2 (noted equation [1]).

$${C}_{{elec}_{—} opt} ( {T}_{opt} ) = \frac{2}{3} \frac{R}{λ} {T}_{opt} \qquad Equation [ 1 ]$$

The second relative movement M₂ between the electrode 10 and counter-electrode 30 is therefore suitable for modifying the electrostatic torque according to the thrust force undergone by the rotor 2. The second relative movement M₂ therefore depends on the speed of the air flow.

### Second Relative Movement: Variable Overlap

The counter-electrode 30 presents an orthogonal projection on the electrode 10 for a given position of the rotor 2, the orthogonal projection having an area. The stator 1 and rotor 2 are configured in such a way that the second relative movement M₂ between the electrode 10 and counter-electrode 30 modifies the area for said given position of the rotor 2. The orthogonal projection can be simulated to a radial projection.

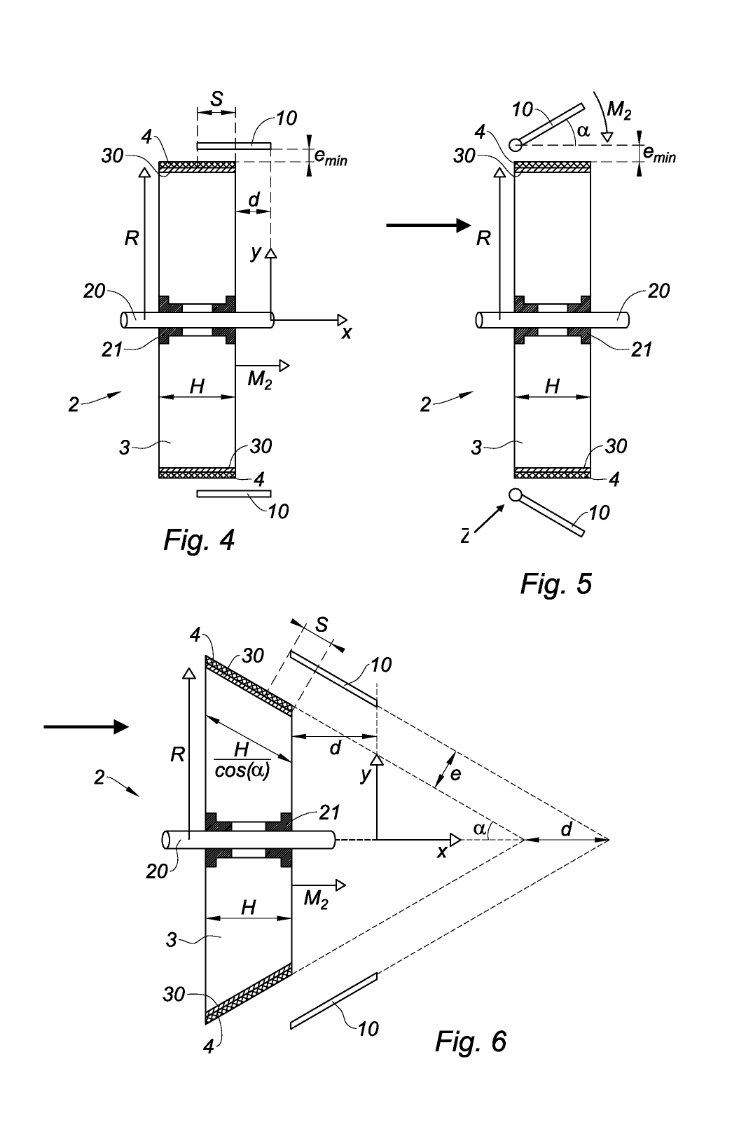

As illustrated in FIG. 4, the blade 3 is mounted movable in translation with respect to the stator 1, along a translation axis parallel to the axis of rotation x which can be the rotary shaft 20, so as to allow the second relative movement M₂ between the electrode 10 and counter-electrode 30. The electrode 10 and counter-electrode 30 present a constant distance eₘᵢₙ for a given position of the rotor 2. Naturally, the distance eₘᵢₙ is not strictly constant considering the precision of manufacturing of the parts or the possible discharge of the dielectric material 4 on the counter-electrode 30. On the other hand, the overlap surface S of the electrode 10 and counter-electrode 30 (in the sense of a contact-free overlap) varies for said given position of the rotor 2. As illustrated in FIG. 4, the air flow tends to move the blade 3 in translation along the translation axis, and produces the second relative movement M₂. For a given position of the rotor 2, the second relative movement M₂ between the electrode 10 and counter-electrode 30 is therefore a translational movement. The speed of the air flow therefore causes an increase of the overlap surface S between the electrode 10 and counter-electrode 30. In the illustrated example, the air flow materialised by an arrow can flow from left to right driving the blades 3 in the direction of the stator 1.

The electrostatic torque then verifies the following relation:

$${C}_{elec} = \frac{1}{2} \times \frac{π R ( H - d ) \times {ɛ}_{0}}{{e}_{min}} \times N \times {V}^{2}$$

where:
d is the displacement of the blade 3 along the translation axis,
H is the longitudinal dimension of the blade 3 along the axis of rotation x.

From equation [1], it is possible to determine the ideal displacement d of the blade 3 along the translation axis in order to extract a maximum amount of energy.

$$d ( T ) = H - \frac{4 \times {T}_{opt} \times {e}_{min}}{3 π \times λ \times {ɛ}_{0} \times N \times {V}^{2}}$$

The table below sets out the values of different parameters between an initial state where the electrostatic coupling is zero and a final state where the electrostatic coupling is maximal.

| | Initial state | Final state |
|---|---|---|
| Overlap surface S | 0 | πR(H-d) |
| Distance between electrodes e | eₘᵢₙ | eₘᵢₙ |
| Displacement d | H | 0 |
| Electric torque C_{elec} | 0 | $\frac{1}{2} \times \frac{πRH \times {ɛ}_{0}}{e} \times N \times {V}^{2}$ |

### Second Relative Movement: Overlap and Variable Air-Gap

The counter-electrode 30 presents an orthogonal projection on the electrode 10 for a given position of the rotor 2, the orthogonal projection having an area. The electrode 10 and counter-electrode 30 present a distance e for a given position of the rotor 2. The stator 1 and rotor 2 are configured in such a way that the second relative movement M₂ between the electrode 10 and counter-electrode 30 modifies:
the area for said given position of the rotor 2,
and the distance e for said given position of the rotor 2.

As illustrated in FIG. 6, the blade 3 is mounted movable in translation with respect to the stator 1, along a translation axis parallel to the axis of rotation x of the blade 3 and possibly of the rotary shaft 20 so as to allow the second relative movement between the electrode 10 and counter-electrode 30. For said given position of the rotor 2, the counter-electrode 30 extends in a longitudinal direction (noted first direction) defining an angle a with the axis of rotation x of the blade 3 and of the rotary shaft 20 if applicable. For said given position, the electrode 10 extends in a longitudinal direction parallel to the first direction. According to a possible form of execution, the stator 1 and rotor 2 are of conical shape.

As illustrated in FIG. 6, the air flow tends to move the blade 3 in translation along the translation axis and produces the second relative movement M₂. For example, for an air flow directed from left to right in the illustrated example, the rotor moves in the direction of the stator 1. For a given position of the rotor 2, the second relative movement M₂ between the electrode 10 and counter-electrode 30 is therefore a translational movement. It therefore results from the speed of the air flow that:
the overlap surface S between the electrode 10 and counter-electrode 30 increases,
the air-gap between the electrode 10 and counter-electrode 30 decreases.

The electrostatic torque then verifies the relation:

$${C}_{elec} = \frac{1}{2} \times \frac{π R ( \frac{H}{cos ( α )} - d \times cos ( α ) ) \times {ɛ}_{0}}{d \times sin ( α )} \times N \times {V}^{2}$$

where:
d is the displacement of the blade 3 along the translation axis,
H is the longitudinal dimension of the blade 3 measured along the axis of rotation x.

From equation [1], it is possible to determine the ideal displacement d of the blade 3 along the translation axis in order to extract a maximum amount of energy.

$$d ( T ) = \frac{H}{{cos}^{2} ( α )} \times \frac{1}{( 1 + \frac{4 tan ( α ) \times {T}_{opt}}{3 π \times λ \times {ɛ}_{0} \times N \times {V}^{2}} )}$$

The table below sets out the values of different parameters between an initial state where the electrostatic coupling is zero and a final state where the electrostatic coupling is maximal.

| | Initial | |
|---|---|---|
| | state | Final state |
| Overlap surface S | 0 | $πR ( \frac{H}{cos ( α )} - \frac{{e}_{min}}{tan ( α )} )$ |
| Distance between | Hsin(α) | eₘᵢₙ |
| electrodes e | | |
| Displacement d | $\frac{H}{{cos}^{2} ( α )}$ | $\frac{{e}_{min}}{sin ( α )}$ |
| Electric torque C_{elec} | 0 | $\frac{1}{2} \times \frac{πR ( \frac{H}{cos ( α )} - \frac{{e}_{min}}{tan ( α )} ) {ɛ}_{0}}{{e}_{min}} \times N \times {V}^{2}$ |

### Second Relative Movement: Variable Air-Gap

The electrode 10 and counter-electrode 30 present a distance e for a given position of the rotor 2. The stator 1 and rotor 2 are configured in such a way that the second relative movement M₂ between the electrode 10 and counter-electrode 30 modifies the distance e for said given position of the rotor 2.

As illustrated in FIG. 5, the electrode 10 can be mounted swivelling with respect to the stator 1 around a swivel axis Z perpendicular to the axis of rotation x of the blade 3 and possibly of the rotary shaft 20, so as to allow the second relative movement M₂ between the electrode 10 and counter-electrode 30. On the other hand, the overlap surface of the electrode 10 and counter-electrode 30 remains unchanged for said given position of the rotor 2.

As illustrated in FIG. 5, the speed of the air flow tends to make the counter-electrode 30 swivel and produces the second relative movement M₂. For a given position of the rotor 2, the second relative movement M₂ between the electrode 10 and counter-electrode 30 is therefore a rotational movement. The speed of the air flow then results in a reduction of the air-gap e between the electrode 10 and counter-electrode 30. For example, with an air flow directed from left to right, a part of the electrode 10 swivels to move towards the counter-electrode 30.

The electrostatic torque then verifies the following relation:

$${C}_{elec} = \frac{1}{2} \times \frac{π R \times ln ( 1 + \frac{H sin ( α )}{e} ) \times {ɛ}_{0}}{α} \times N \times {V}^{2}$$

where:
H is the longitudinal dimension of the blade 3 measured along the axis of rotation x of the rotor 2,
α is the angle formed between the electrode 10 and an axis parallel to the axis of rotation x of the rotor 2 which passes through the swivel axis Z of the electrode 10.

The table below sets out the values of different parameters between an initial state where the electrostatic coupling is zero and a final state where the electrostatic coupling is maximal.

| | Initial state | Final state |
|---|---|---|
| Overlap surface S | πRH | πRH |
| Distance between electrodes e | ∞ | eₘᵢₙ |
| Rotation α | 90° | 0° |
| Electric torque C_{elec} | 0 | $\frac{1}{2} \times \frac{πRH \times {ɛ}_{0}}{{e}_{min}} \times N \times {V}^{2}$ |

This embodiment enables an electrostatic coupling to be generated depending only on the speed of the air flow and the dimensions of the stator 1, circumventing the rotation effect of the rotor 2.

### Rotor and Stator

The rotor 2 comprises a rotary shaft 20 on which the blade 3 is mounted. The blade 3 presents a distal end with respect to the axis of rotation x. The counter-electrode 30 is preferentially mounted on the distal end of the blade 3.

As illustrated in FIGS. 4 to 6 and 10, the rotor 2 can comprise a bearing 21 arranged to receive the rotary shaft 20.

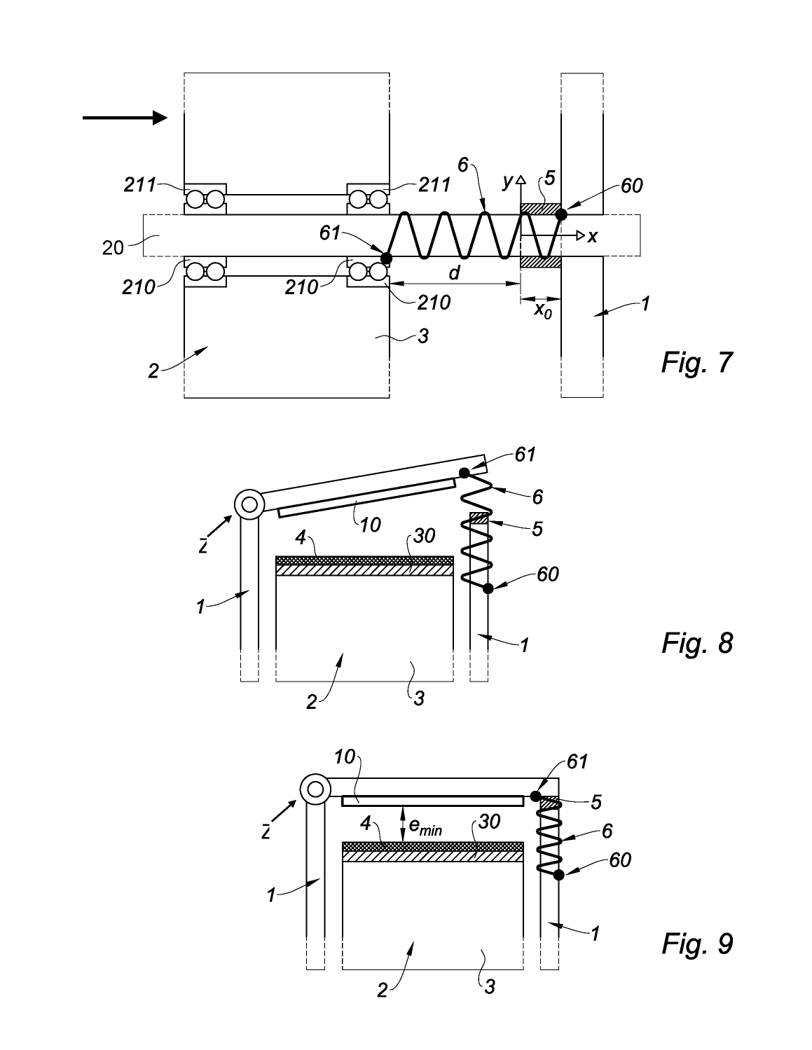

As illustrated in FIG. 7, the rotor 2 can comprise a ball-bearing arranged to receive the rotary shaft 20. The ball-bearing comprises a fixed part 210 and a movable part 211.

As illustrated in FIGS. 13 to 16, the rotor 2 and rotary shaft 20 can be securedly united in rotation. The stator 1 can then comprise a ball-bearing arranged to receive the rotary shaft 20. The ball-bearing comprises a fixed part 210 and a movable part 211.

As illustrated in FIG. 2, the stator 1 can comprise a set of electrodes 10 arranged preferably uniformly around the trajectory followed by the blade 3 on a rotation of the rotor 2.

Advantageously, the rotor 2 comprises Np blades 3, Np being an integer greater than or equal to 1, a counter-electrode 30 being fitted on each blade 3. The stator 1 advantageously comprises a set of Nₑ electrodes, Nₑ being an integer verifying Nₑ=2Nₚ. Such a distribution is thereby optimised in order to have a maximum ratio Nₑ×(Cₘₐₓ−Cₘᵢₙ), where Cₘₐₓ and Cₘᵢₙ are respectively the maximum and minimum electric capacitance obtained on a rotation of the rotor 2.

Advantageously, the stator 1 comprises an electric circuit in which the induced current flows, the electric circuit being connected to said at least one electrode 10.

Connection of the electric circuit only to the electrodes 10 of the stator 1 (Slot-effect connection), rather than both to the electrodes 10 of the stator and to the counter-electrodes 30 of the rotor 2 (Cross-wafer connection), is therefore easier to implement.

### Adjustment of the Second Relative Movement

The air flow is designed to generate a mechanical torque, noted C_{meca}, exerted on the rotary shaft 20. The electrostatic converter advantageously comprises adjustment means, also called adjustment device, configured to adjust the second relative movement M₂ between the electrode 10 and counter-electrode 30 so that the modified electrostatic torque, noted C_{elec}, verifies 0.85×C_{meca}≤C_{elec}≤C_{meca} preferentially 0.9×C_{meca}≤C_{elec}≤C_{meca}, and more preferentially C_{elec}=C_{meca}.

When the second relative movement M₂ between the electrode 10 and counter-electrode 30 increases the generated electrostatic torque, the adjustment device is arranged to oppose said second relative movement M₂. A limit air flow rate (noted Uₗᵢₘ) exists above which the optimal mechanical torque becomes higher than the maximum electrostatic torque (i.e. maximum overlap surface and/or minimum air-gap). The blade 3 must no longer move in the translation direction when the speed of the air flow reaches Uₗᵢₘ. For this purpose, the electrostatic converter comprises a stop 5 arranged to define an end-of-travel position of the second relative movement M₂ between the electrode 10 and counter-electrode 3. The stop 5 is arranged so that the electrode 10 and counter-electrode 30 are situated at a distance from one another in the end-of-travel position.

In the case of a second relative movement M₂ with variable overlap, the limit air flow speed can be determined in the following manner:

$$\begin{matrix} & {C}_{meca} ( U = {U}_{lim} ) & = & {C}_{elec} ( d = 0 ) \\ ⇔ & \frac{8}{27} \frac{ρπ {R}^{3} {U}_{lim}^{2}}{λ} & = & \frac{1}{2} \times \frac{π RH {ɛ}_{0}}{{e}_{min}} \times N \times {V}^{2} \\ ⇔ & {U}_{lim} & = & \sqrt{\frac{27}{16} \times \frac{λ H {ɛ}_{0}}{ρ {R}^{2} {e}_{min}} \times N \times {V}^{2}}\end{matrix}$$

Ideally, the adjustment device is configured to exert a force Fᵣₑₚ opposing the second relative movement M₂, verifying the following relation:

$${F}_{rep} ( d ) = {T}_{opt} = \frac{3 π \times λ \times {ɛ}_{0} \times N \times {V}^{2}}{4 \times {e}_{min}} ( H - d )$$

In the case of a second relative movement M₂ with overlap and variable air-gap, the limit air flow speed can be determined in the following manner:

$$\begin{matrix} & {C}_{meca} ( U = {U}_{lim} ) & = & {C}_{elec} ( d = \frac{{e}_{min}}{sin ( α )} ) \\ ⇔ & \frac{8}{27} \frac{ρπ {R}^{3} {U}_{lim}^{2}}{λ} & = & \frac{1}{2} \times \frac{π R ( \frac{H}{cos ( α )} - \frac{{e}_{min}}{tan ( α )} ) {ɛ}_{0}}{{e}_{min}} \times N \times {V}^{2} \\ ⇔ & {U}_{lim} & = & \sqrt{\frac{27}{16} \times \frac{λ ( \frac{H}{cos ( α )} - \frac{{e}_{min}}{tan ( α )} ) {ɛ}_{0}}{ρ {R}^{2} {e}_{min}} \times N \times {V}^{2}}\end{matrix}$$

Ideally, the adjustment device is configured to exert a force Fᵣₑₚ opposing the second relative movement M₂, verifying the following relation:

$${F}_{rep} ( d ) = {T}_{opt} = \frac{3 π \times λ \times {ɛ}_{0} \times N \times {V}^{2}}{4 \times tan ( α )} \times ( \frac{H}{d \times {cos}^{2} ( α )} - 1 )$$

In the case of a second relative movement M₂ with variable air-gap, the limit air flow speed verifies the following relation:

$${U}_{lim} = \sqrt{\frac{27}{16} \times \frac{λ H {ɛ}_{0}}{ρ {R}^{2} {e}_{min}} \times N \times {V}^{2}}$$

As illustrated in FIGS. 7 to 9, the adjustment device can comprise a spring 6 arranged to oppose the second relative movement M₂. The spring 6 advantageously comprises a first end 60 mounted fixed with respect to the stator 1. The spring 6 advantageously comprises a second end 61 mounted movable with respect to the stator 1. More precisely, the rotor 2 can comprise a ball-bearing arranged to receive the rotary shaft 20. The ball-bearing comprises a fixed part 210 and a movable part 211. The second end 61 of the spring 6 is fitted on the fixed part 210 of the ball-bearing. In the illustrated example, the adjustment device opposes movement of the rotor in the direction of the stator (here from left to right) caused by the air flow on the blade 3.

In the embodiment illustrated in FIG. 13, the spring 6 comprises a first end 60 fixed to the movable part 211 of the ball-bearing. The spring 6 comprises a second end 61 mounted movable with respect to the stator 1.

In the case of a second relative movement M₂ with variable overlap, a linear mechanical spring 6 is particularly well-suited as the force Fᵣₑₚ(d) is of affine type. The spring 6 is advantageously configured to verify the following relations:

$$\{ \begin{matrix}{x}_{0} > 0 \\ {I}_{0} = {x}_{0} + H \\ {F}_{rep} ( d = 0 ) = T ( {U}_{lim} ) = kH\end{matrix}$$

where:
x₀ is the original position of the spring 6,
k is the stiffness of the spring 6,
l₀ is the no-load length of the spring 6.

The first equation enables the second end 61 of the spring 6 to be correctly positioned so that the end-of-travel position of the stop 5 is reached. The second equation enables the rotor 2 to be located with respect to the stator 1 in such a way that no force is exerted on the converter and the initial electrostatic torque is nil. The third equation ensures that the thrust force undergone by the rotor 2 at the limit speed Uₗᵢₘ and the force of the spring 6 at the time of contact with the stop 5 are equal to one another, which fixes the stiffness value k of the spring 6.

In this way, as illustrated in FIG. 11, such a spring 6 can exert a force Fᵣₑₚ opposing the second relative movement M₂. When the speed of the air flow is low (less than 1.5 m/s), the modified electrostatic torque is substantially equal to the mechanical torque exerted on the rotor 2 (graphically, curve plot A is substantially identical to curve plot B) and electric power extraction is possible. In the state of the art, for these low speeds, the electrostatic torque fixed is higher than the mechanical torque exerted on the rotor 2 (graphically, curve plot C is above curve plot B) and electric power extraction is impossible.

In the case of a second relative movement M₂ with variable overlap and air-gap, the spring 6 is advantageously configured to verify the following relations:

$$\{ \begin{matrix}\frac{{e}_{min}}{sin ( α )} < {x}_{0} \\ {x}_{0} + \frac{{e}_{min}}{sin ( α )} < {I}_{0} < {x}_{0} + \frac{H}{{cos}^{2} ( α )} \\ {F}_{rep} ( d = \frac{{e}_{min}}{sin ( α )} ) = T ( {U}_{lim} ) = k ( {I}_{0} - ( \frac{R}{tan ( α )} - H + \frac{{e}_{min}}{sin ( α )} - {x}_{0} ) )\end{matrix}$$

The first equation enables the second end 61 of the spring 6 to be correctly positioned so that the end-of-travel position of the stop 5 is reached. The second equation enables the rotor 2 to be located with respect to the stator 1 in such a way that no force is exerted on the converter (the initial electrostatic torque not necessarily being nil). The third equation ensures that the thrust force undergone by the rotor 2 at the limit speed Uₗᵢₘ and the force of the spring 6 at the time of contact with the stop 5 are equal to one another, which fixes the stiffness value k of the spring 6.

Such a spring 6 can therefore exert a force Fᵣₑₚ opposing the second relative movement M₂.

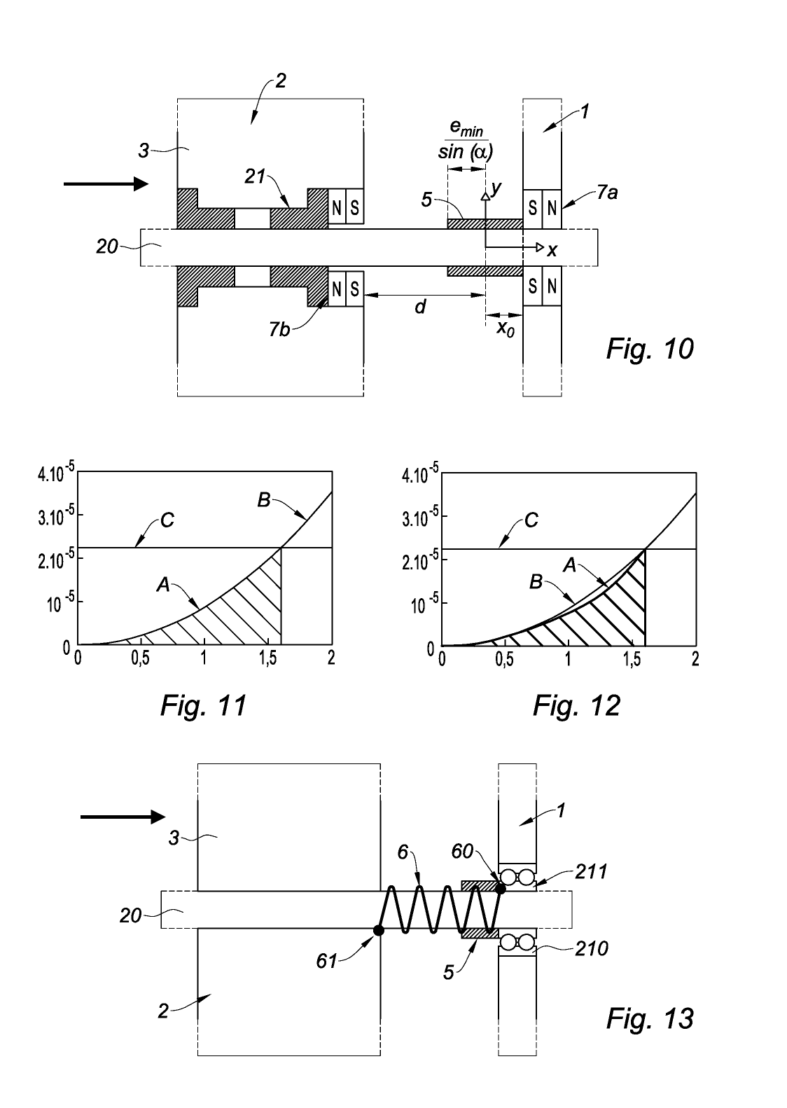

As illustrated in FIG. 10, the adjustment device can comprise first and second magnets 7a, 7b respectively arranged on the stator 1 and on the rotor 2, with identical polarities N, S facing one another, to oppose the second relative movement M₂. The first and second magnets 7a, 7b present dimensions and relative positions suitable to exert a force Fᵣₑₚ opposing the second relative movement M₂.

As illustrated in FIG. 12, such an adjustment device can exert a force Fᵣₑₚ opposing the second relative movement M2. When the speed of the air flow is low (less than 1.5 m/s), the modified electrostatic torque is substantially equal to the mechanical torque exerted on the rotor 2 (graphically, curve plot A is substantially identical to curve plot B) and electric power extraction is possible. In the state of the art, for these low speeds, the constant electrostatic torque is higher than the mechanical torque exerted on the rotor 2 (graphically, curve plot C is above curve plot B) and electric power extraction is impossible.

### Electrode(s) and Counter-Electrode(s)

In the embodiments illustrated in the foregoing, the counter-electrode 30 is coated with the dielectric material 4. However, according to a variant that is not illustrated, the electrode 10 can be coated with the dielectric material 4 whereas the counter-electrode 30 has a free surface.

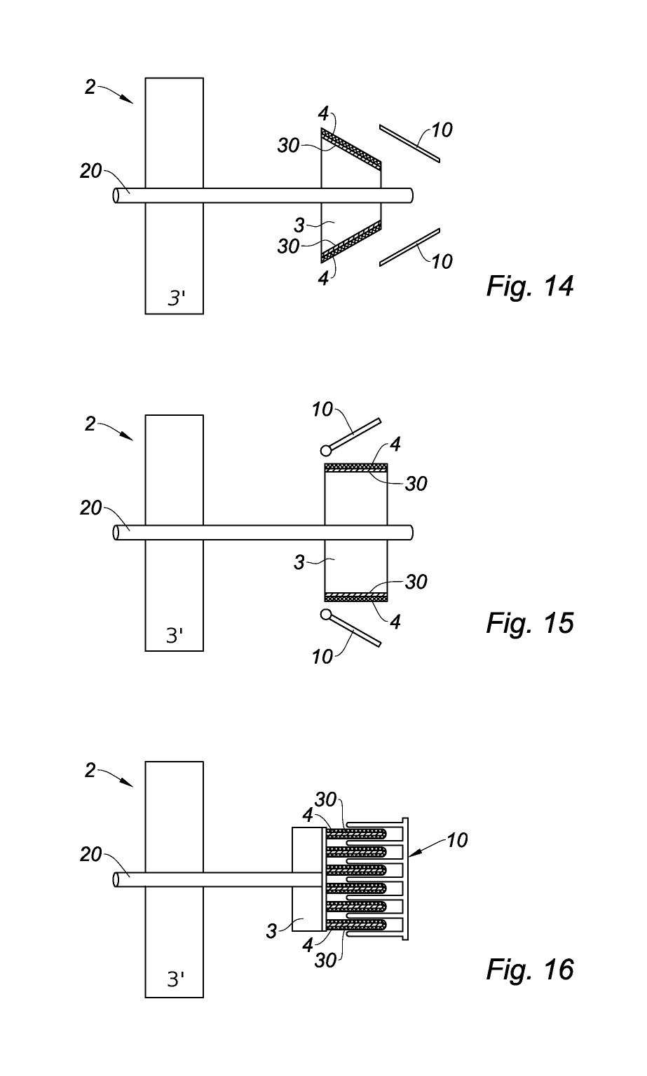

As illustrated in FIGS. 14 to 16, the electrode 10 and counter-electrode 30 can be located downstream from the rotor 2, the rotor 2 and the rotary shaft 20 being securedly united in rotation.

As illustrated in FIG. 16, the electrostatic converter can comprise a set of interdigitated electrodes 10 and counter-electrodes 30.

In an embodiment which can be illustrated in FIGS. 14, 15 and 16, the rotor can comprise at least one additional blade 3′ designed to receive an air flow, blade 3 being movable in rotation with respect to the stator 1 around an axis of rotation x designed to coincide with a direction of the air flow. The air flow on the blade 3′ causes rotation of the rotor 2. Blade 3′ is arranged upstream and blade 3 is arranged downstream. The rotary shaft 20 is fixed to blade 3 and to blade 3′. As for the other embodiments, the stator 1 and rotor 2 are configured to allow a second relative movement M₂ between the at least one electrode 10 and counter-electrode 30 so as to modify the generated electrostatic torque C_{elec}, the second relative movement M₂ between the electrode 10 and counter-electrode 30 being designed to be achieved by the air flow.

In the different embodiments illustrated, the air flow causes the first relative movement M₁ and also the second relative movement M₂.

The invention is not limited to the embodiments set out herein. The person skilled in the trade is able to consider their technically operative combinations and to substitute equivalents for the latter.

1. Electrostatic converter, comprising:
a stator provided with at least one electrode;
a rotor mounted movable in rotation with respect to the stator, the rotor comprising at least one blade provided with a counter-electrode, the at least one electrode or the counter-electrode being coated with a dielectric material suitable to be biased, the at least one electrode, the dielectric material and the counter-electrode defining a capacitor having a variable electric capacitance, the at least one blade being designed to receive an air flow, the at least one blade being movable in rotation with respect to the stator around an axis of rotation designed to coincide with a direction of the air flow, the air flow causing rotation of the at least one blade around the axis of rotation;
wherein the stator and rotor are configured to;
enable a first relative rotational movement between the at least one electrode and counter-electrode, around the axis of rotation so as to generate an electrostatic torque;
allow a second relative movement between the at least one electrode and the counter-electrode so as to modify the electrostatic torque generated, the air flow causing the second relative movement between the at least one electrode and the counter-electrode.

2. The electrostatic converter according to claim 1, wherein the second relative movement between the at least one electrode and the counter-electrode comprises swivelling of the electrode in a direction perpendicular to the axis of rotation.

3. The electrostatic converter according to claim 1, wherein the second relative movement between the at least one electrode and counter-electrode comprises translation of the rotor along the axis of rotation.

4. The electrostatic converter according to claim 1, wherein an increase of the speed of the air flow along the axis of rotation causes in an increase of the electrostatic torque generated until a threshold value is reached.

5. The electrostatic converter according to claim 1, comprising an adjustment device arranged to oppose said second relative movement

6. The electrostatic converter according to the combination of claim 4, wherein the second relative movement between the at least one electrode and the counter-electrode is configured to increase the electrostatic torque generated, the adjustment device being arranged to oppose said second relative movement when the speed of the air flow along the axis of rotation increases.

7. The electrostatic converter according to claim 5, wherein the air flow being designed to generate a mechanical torque noted C_{meca} exerted on the rotor, the adjustment device is configured to adjust the second relative movement between the at least one electrode and the counter-electrode so that the modified electrostatic torque, noted C_{elec}, verifies 0.85×C_{meca}≤C_{elec}≤C_{meca}.

8. The electrostatic converter according to claim 5, wherein the adjustment device comprises a spring arranged to oppose the second relative movement when the speed of the air flow along the axis of rotation increases.

9. The electrostatic converter according to claim 5, wherein the adjustment device comprises first and second magnets respectively arranged on the stator and on the rotor, with identical polarities facing one another, to oppose the second relative movement when the speed of the air flow along the axis of rotation increases.

10. The electrostatic converter according to claim 1, wherein the at least one electrode is mounted swivelling with respect to the stator around a swivel axis perpendicular to the axis of rotation so as to allow the second relative movement between the electrode and the counter-electrode.

11. The electrostatic converter according to claim 1, comprising a stop arranged to define an end-of-travel position of the second relative movement between the at least one electrode and the counter-electrode when the speed of the air flow along the axis of rotation increases, the stop being arranged in such a way that the at least one electrode and the counter-electrode are located at a distance from one another in the end-of-travel position.

12. The electrostatic converter according to claim 1, wherein the dielectric material is an electret.

13. The electrostatic converter, comprising:
a stator provided with at least one electrode;
a rotor comprising at least one counter-electrode, the rotor being movable in rotation with respect to the stator around an axis of rotation, the at least one electrode or the at least one counter-electrode being coated with a dielectric material suitable to be biased;
a rotary shaft comprising a blade designed to receive an air flow, the air flow allowing a first relative rotational movement between the at least one electrode and the at least one counter-electrode around the axis of rotation of the rotor so as to generate an electrostatic torque;
wherein the stator and the rotor are configured to allow a second relative movement between the at least one electrode and the counter-electrode so as to modify the electrostatic torque generated, the second relative movement between the at least one electrode and the at least one counter-electrode being designed to be achieved by the air flow.

14. The electrostatic converter according to claim 13, wherein the second relative movement between the at least one electrode and the at least one counter-electrode comprises swivelling of the at least one electrode around an axis perpendicular to the axis of rotation.

15. The electrostatic converter according to claim 13, wherein the second relative movement between the at least one electrode and the at least one counter-electrode comprises translation of the rotor along the axis of rotation.

16. The electrostatic converter according to claim 13, wherein an increase of the speed of the air flow along the axis of rotation results in an increase of the electrostatic torque generated until a threshold value is reached.

17. The electrostatic converter according to claim 13, comprising an adjustment device arranged to oppose said second relative movement

18. The electrostatic converter according to claim 16, wherein the second relative movement between the at least one electrode and the at least one counter-electrode is configured to increase the electrostatic torque generated, the adjustment device being arranged to oppose said second relative movement when the speed of the air flow along the axis of rotation increases.

19. The electrostatic converter according to claim 17, wherein the adjustment device comprises a spring arranged to oppose the second relative movement when the speed of the air flow increases along the axis of rotation or first and second magnets respectively arranged on the stator and on the rotor, with identical polarities facing one another, to oppose the second relative movement along the axis of rotation when the speed of the air flow increases.

20. The electrostatic converter according to claim 13, wherein the at least one electrode is mounted swivelling with respect to the stator around a swivel axis perpendicular to the axis of rotation so as to allow the second relative movement between the at least one electrode and the at least one counter-electrode.
